(19) United States
(12) Patent Application Publication
(10) Pub. No.: US 2004/0100064 A1
(43) Pub. Date: May 27, 2004

(54) Trailer particularly suited to hauling crushed and flattened vehicles

(76) Inventor: Charles Bush SR., Rochester Hills, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/352,360

(22) Filed: Jan. 27, 2003

Related U.S. Application Data
(63) Continuation-in-part of application No. 10/304,417, filed on Nov. 26, 2002.

(51) Int. Cl. B62D 33/00

(52) U.S. Cl. 280/181

(57) ABSTRACT

This invention resides in a hauling trailer, particularly of the type used to transport scrap such as crushed and flattened vehicles. A trailer according to the invention broadly includes a floor with walls and one open side, and a hinged door structure that allows one of the long sides of the trailer to be opened and closed for loading and unloading. In the preferred embodiment, the door structure opens centrally, but includes two panels on either side which are respectively hinged to one another, resulting in an articulated structure that provides more clearance. The doors are preferably cross-braced, and are covered with mesh and/or canvas to retain smaller loose components from falling out. The height of the doors is also adjusted to suite trailer having a lower floor between front and rear axles, and hinged braces are provided to maintain at least the top bridge of the doors in a straight and aligned condition when the doors are closed.

### REFERENCE TO RELATED APPLICATION

This application is a continuation-in-part of U.S. patent application Ser. No. 10/304,417, filed Nov. 26, 2002, the entire content of which is incorporated herein by reference.

### FIELD OF THE INVENTION

This invention relates generally to waste and scrap hauling and, in particular, to a trailer with four sides, at least one of which opens to receive scrap including crushed/flattened vehicles.

### BACKGROUND OF THE INVENTION

The recycling of wrecked cars now represents a substantial business. Such vehicles are first stripped of non-metal parts and hazardous materials, then crushed or flattened to consume less space during transport to a recycling station where they are chipped into small pieces. The small pieces are then sold to be melted down.

Standard flatbed trailers are commonly used to transport the crushed or flattened vehicles. The flattened vehicles are typically loaded on the flatbed in stacks using a forklift, and each stack is secured with tie-down chains.

There are disadvantages associated with the use of flatbed trailers, however. For one, when the wrecked vehicles are crushed or flattened, stress is put on various parts such as mirrors and moldings that may become dislodged or loose in transit, resulting in dangerous debris on the highway. Another disadvantage is that if the load has shifted, adjustments should be made to the tie-downs, which are difficult to inspect and secure. Manipulating the chains across the stacks can be unsafe, as the stacks of vehicles are unstable and are prone to slip or tip over.

Various alternative trailers are used to overcome these disadvantages. A common approach is the use of a three-sided trailer of the type disclosed, for example, in U.S. Pat. No. 5,599,058. A twelve-inch high retainer wall of solid sheet steel is also provided on the three walled sides around the bottom periphery to prevent any small pieces of debris from falling off the trailer bed on those sides. The open side of the trailer is located on the side of the transport vehicle that will be toward the berm of the road, so that any debris falling in that direction will fall to the side of the road.

In accordance with U.S. Pat. No. 5,876,164, there is provided a device for carrying car frames or the like, comprising a rectangular base member comprising at least one trailer bed, and means for mounting said base member on wheels. Transverse members are spacedly mounted on the base member and a first vertical protection wall is mounted at a front end of the base member. A second vertical protection wall is mounted on one longitudinal side of the base member, the other longitudinal side being free of vertical protection wall, and a third vertical protection wall is mounted at a rear end of the base member. Support means extend vertically from the transverse member and are aligned along a straight line spaced at an equal distance from the second protection wall. A non-slip member is disposed along the other longitudinal side of the base member, and means for securing a load of car frames are stacked on the transverse members between the support means and the non-slip members.

In accordance with a preferred embodiment, the base member comprises a front trailer bed and a rear trailer bed, the rear trailer bed being articulated to the front trailer bed, the first vertical protection wall being mounted at the front of the front trailer bed, the third vertical protection wall being mounted at the rear of the rear trailer bed, the second vertical protection wall being mounted on the longitudinal left sides of both front and rear trailer beds.

Despite advances of the type described above, the need remains for a trailer with a fourth side that opens and closes. In the United States, this need has increased in urgency due to a recently enacted law requiring that all four sides of car frame haulers be enclosed at least up to the level of the load.

### SUMMARY OF THE INVENTION

This invention resides in a hauling trailer, particularly of the type used to transport scrap such as crushed and flattened vehicles. A trailer according to the invention broadly includes a floor with walls and one open side, and a hinged door structure that allows one of the long sides of the trailer to be opened and closed for loading and unloading.

In the preferred embodiment, the door structure opens centrally, but includes two panels on either side which are respectively hinged to one another, resulting in an articulated structure that provides more clearance. The doors are preferably cross-braced, and are covered with mesh and/or canvas to retain smaller loose components from falling out. The height of the doors is also adjusted to suite trailer having a lower floor between front and rear axles, and hinged braces are provided to maintain at least the top bridge of the doors in a straight and aligned condition when the doors are closed.

### BRIEF DESCRIPTION OF THE DRAWINGS

FIG. 1 is a simplified perspective view of the preferred embodiment according to the invention in a closed condition;

FIG. 2 is a simplified perspective view of the preferred embodiment according to the invention in an open condition;

FIG. 3 is drawing that shows an alternative embodiment according to the invention; and

FIG. 4 is drawing that shows a further alternative embodiment according to the invention.

### DETAILED DESCRIPTION OF THE INVENTION

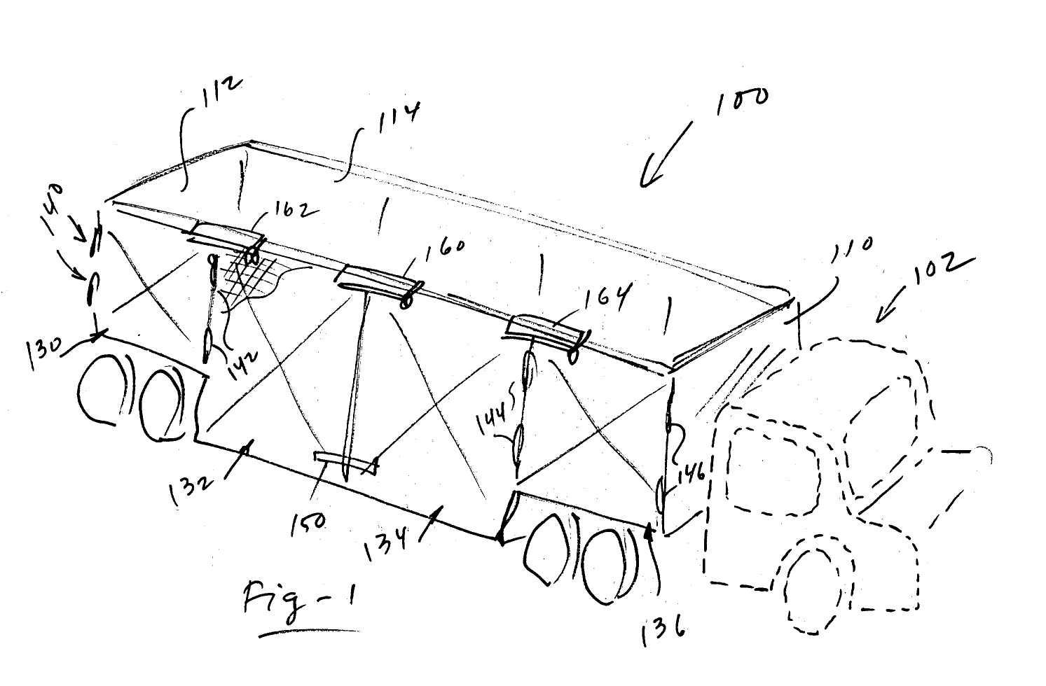

Now turning to the drawings, FIG. 1 is a simplified, perspective view of a preferred embodiment of the invention, depicted generally at 100. The trailer 100 is pulled by a tractor 102 of any conventional design, utilizing any attachment mechanism such as a king-pin plate, as appropriate.

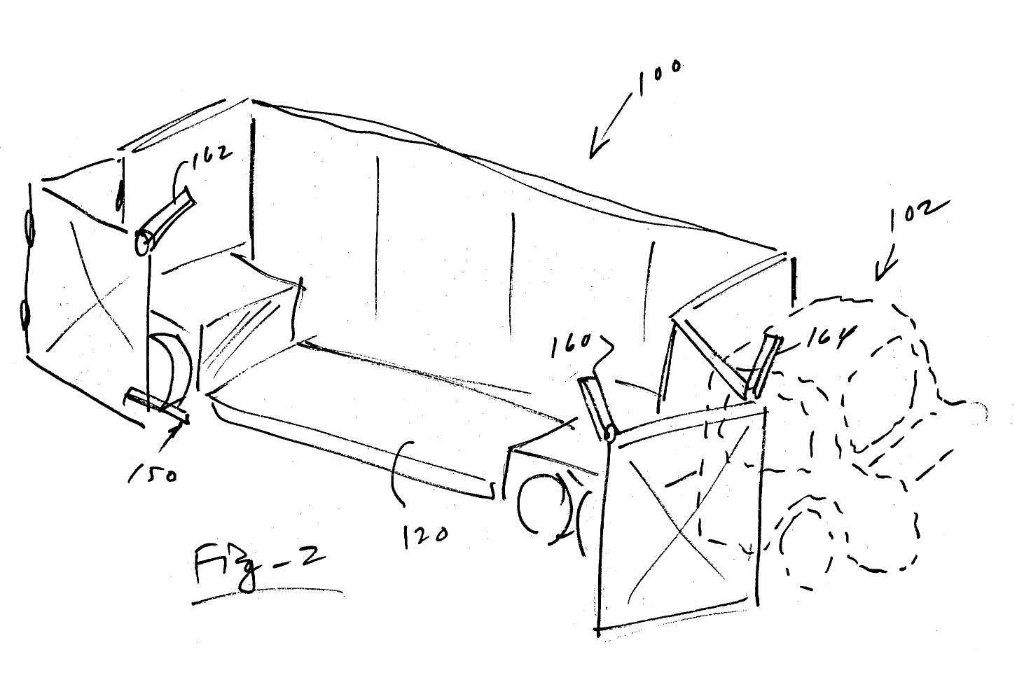

In the preferred embodiment, the trailer 100 includes a front wall 110, a real wall 112, and a side wall 114, extending up from a floor 120, as perhaps best seen in FIG. 2. This leaves an open side along the length of a trailer, which this invention opens and closes for loading/unloading and transport, respectively.

In the preferred embodiment, the wall structure used to close the open side comprises a set of bi-fold doors 130, 132, 134, 136. Portions 130 and 136 are hinged to the rear wall 112 and front wall 110, respectively, using hinges 140 and 146, whereas portions 130 and 136 are hinged to portions 132 and 134 using hinges 142 and 144, respectively. The doors 132 and 134 are fastened together using some form of fastener or latch 150.

In the preferred embodiment, the portions 130, 132, 134, 136 are cross-braced, as shown, and covered with mesh and/or steel grating(s) and/or canvas to retain smaller loose parts from falling out. Also in the preferred embodiment, along the upper edges where the various panels adjoin, hinged 160, 162, 164 are preferably employed to keep at least the upper edge in straight alignment when the panels are closed.

FIG. 2 is a drawing which shows the doors in an open condition, also illustrating the way in which the bi-fold nature of the panels allows access to the inner compartment with relatively tight clearances. Note that the braces 160, 162, 164 are now in an up condition, with latch 150 open.

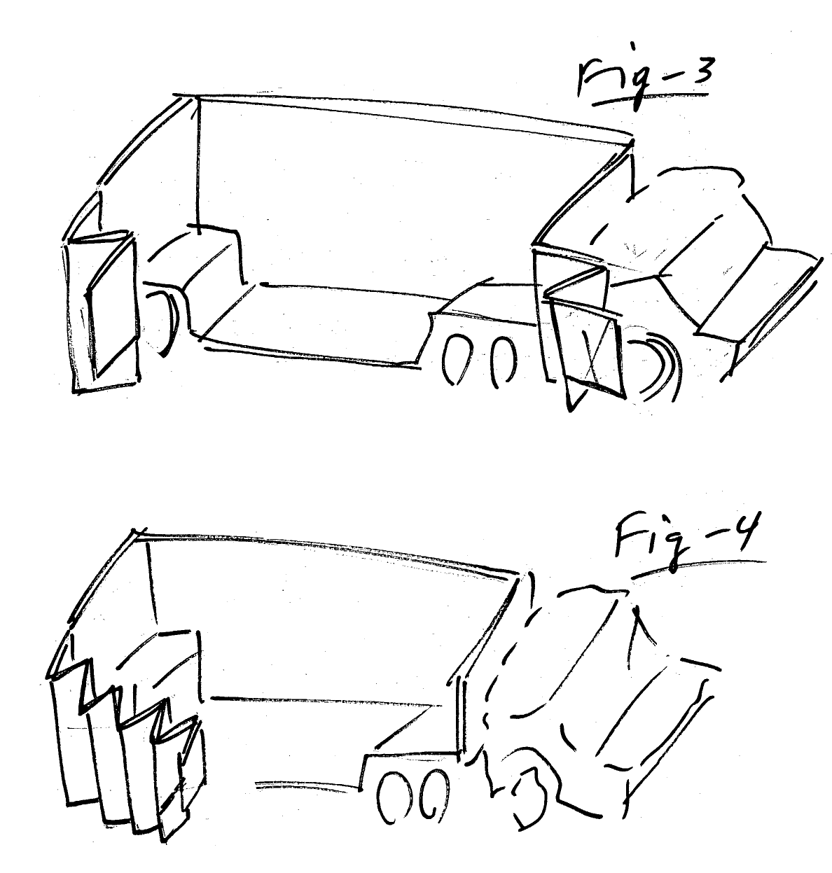

Although a pair of bi-fold doors are shown in the preferred embodiment of FIGS. 1 and 2, the invention is not limited in this regard, and may use tri-fold doors as shown in FIG. 3, or a larger number of articulated panels. In addition, although in the preferred embodiment the panels open centrally, this is not essential either, as the panels may open from one side, as shown in FIG. 4.

I claim:

1. A hauling trailer, comprising:
a floor with wheels thereunder;
front, back and one side wall extending up from the floor creating an open side opposing the side wall; and
one or more articulating doors that may be opened for loading the trailer and closed to cover the open side.

2. The trailer of claim 1, including a pair of side-by-side bi-fold doors.

3. The trailer of claim 1, wherein each doors is constructed using an outer frame filled in with mesh, flexible material, or both.

4. The trailer of claim 1, wherein:
the floor includes a central deeper portion; and
the height of the doors is variable to accommodate the deeper portion.

5. The trailer of claim 1, further including a brace where the doors meet to keep the doors in substantially straight alignment when closed.
